(19) United States
(12) Patent Application Publication
(10) Pub. No.: US 2008/0163204 A1
(43) Pub. Date: Jul. 3, 2008

(54) METHOD AND APPARATUS FOR INVENTORY AND/OR POLICY-BASED MANAGEMENT OF VIRTUAL MACHINES ON A COMPUTING DEVICE

(76) Inventors: Dennis Morgan, Pine Grove, CA (US); Alan D. Ross, Shingle Springs, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/618,342

(22) Filed: Dec. 29, 2006

(51) Int. Cl. G06F 9/455

(52) U.S. Cl. 718/1

(57) ABSTRACT

Methods, apparatuses, articles, and systems for an inventory agent and/or a policy agent of a computing device are described herein. In various embodiments, the inventory agent may be adapted to determine a count of a plurality of virtual machines on the computing device and notify an inventory server of the determined count. The policy agent, in some embodiments, may be adapted to receive an instruction to instantiate or shut down a virtual machine of the plurality of virtual machines of the apparatus, and conditionally disallow the instruction if the instruction does not meet criteria specified by a policy. The computing device may have either or both of the inventory agent or policy agent, either or both of the agents residing on either or both of a management controller of the computing device or a service operating system of the computing device.

### TECHNICAL FIELD

Embodiments relate to the field of data processing and virtualization technology, in particular, to methods and apparatuses for counting the number of virtual machines on a computer system and providing policy decision and enforcement mechanisms, including notifying a server of the count or disabling an unknown virtual machine.

### BACKGROUND

Continuous advancements in virtualization and multi-processor core technology have given rise to the possibility of instantiating and operating a plurality of virtual machines (VMs) on a computing device. Often, one VM of the plurality of VMs may have a service operating system. Such virtual machine may be a virtual machine manager. Other VMs may have other operating systems. Also, management controllers, such as Intel's Active Management Technology (AMT), may be included with the computing device to manage the virtual environment.

The ability to instantiate a plurality of VMs also creates a computer security threat: an unauthorized entity (person, service, application) may cause to be instantiated a virtual machine for malicious uses. Such malicious uses may include interfering with the operations of the computing device having the VMs or using the computing device to launch attacks on the host computer, other devices or networks. Because there is no mechanism for inventorying the number and types of VMs on a computing device, authorized users of the computing device may be unaware of the VM instantiated for malicious uses. Further, such instantiations can not be prevented because there is no mechanism for distinguishing between authorized and unauthorized instantiations.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a flow chart view of selected operations of the methods of various embodiments of the present invention; and

FIG. 3 illustrates an example computer system suitable for use to practice various embodiments of the present invention.

### DETAILED DESCRIPTION OF ILLUSTRATIVE EMBODIMENTS

Illustrative embodiments of the present invention include, but are not limited to, methods and apparatuses for an inventory agent and/or a policy agent of a computing device. In various embodiments, the inventory agent may be adapted to determine a count of a plurality of virtual machines on the computing device and notify an inventory server of the determined count. The policy agent, in some embodiments, may be adapted to receive an instruction to instantiate or shut down a virtual machine of the plurality of virtual machines of the apparatus, and conditionally disallow the instruction if the instruction does not meet criteria specified by a policy. The computing device may have either or both of the inventory agent or policy agent, either or both of the agents residing on either or both of a management controller of the computing device or a service operating system of the computing device.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

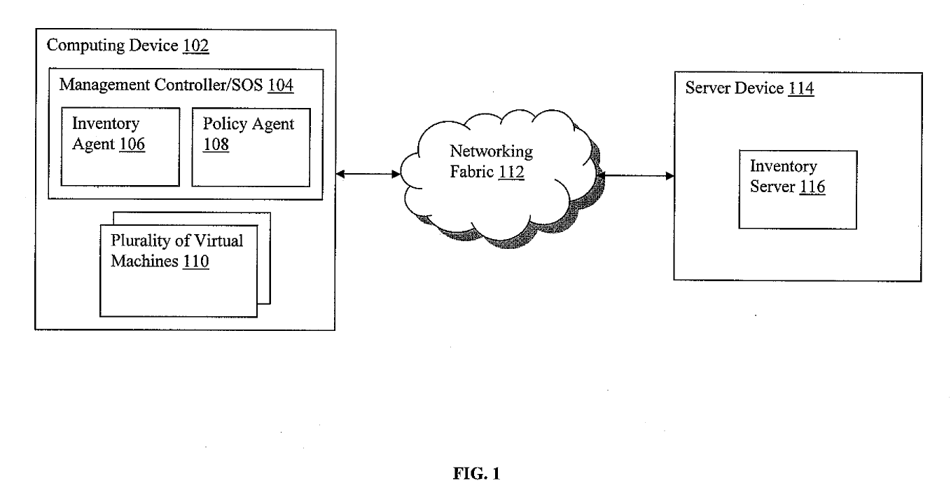

FIG. 1 illustrates an overview of various embodiments of the present invention. As illustrated, a computing device 102 may have an inventory agent 106 and/or a policy agent 108 to inventory and/or manage a plurality of virtual machines 110 of the computing device 102. In various embodiments, the inventory agent 106 may at least count the plurality of virtual machines 110 and notify an inventory server 116 of a server device 114 of the count of the plurality of virtual machines 110 on computing device 102 via a networking fabric 112 connecting the computing device 102 and the server device 114. The inventory agent 106 may also determine the name, size, type, and/or function of at least one of the plurality of virtual machines 110, and may further notify the inventory server 116 of the name, size, type, and/or function of the at least one of the plurality of virtual machines 110. In some embodiments, after counting the plurality of virtual machines 110, the inventory agent 106 may compare the count to a previous count to determine if any virtual machines 110 have been instantiated or shut down, and may notify the inventory server of the new count only if it differs from the previous count. In various embodiments, the policy agent 108 may receive instructions to instantiate or shut down virtual machines 110, and may allow or disallow the execution of the instructions based on a policy. The inventory agent 106 and/or policy agent 108 may each be stored on one of a management controller 104 of the computing device 102 or a service operating system 104 of one of the virtual machines 110 of the computing device 102.

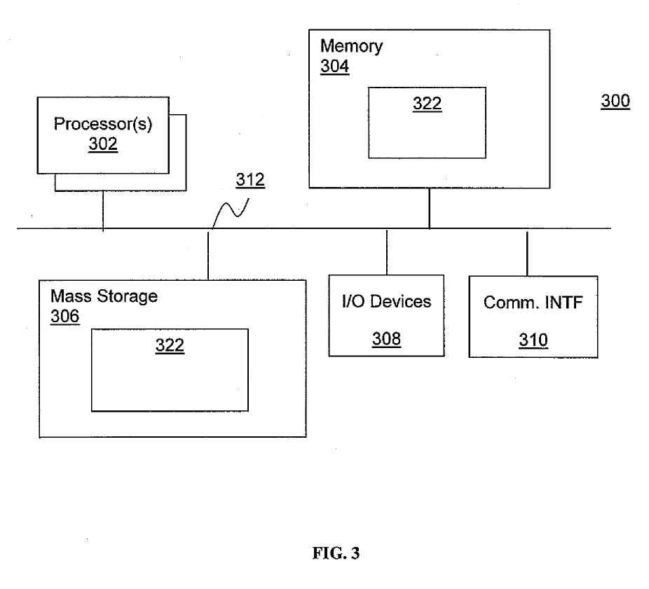

In various embodiments, computing device 102 may be any single- or multi-processor or processor core central processing unit (CPU) computing system. Computing device 102 may be a personal computer (PC), a workstation, a server, a router, a mainframe, a modular computer within a blade server or high-density server, a personal digital assistant (PDA), an entertainment center, a set-top box, or a mobile device. As shown, computing device 102 may be capable of operating a plurality of operating systems (OS) in a plurality of virtual machines (VM) 110 using virtualization technologies. In some embodiments, the OSes may include a service OS (SOS) 104, a capability/user OS (COS), and/or one or more virtual OSes (VOS). As is also shown, computing device 102 may also include a low-level management controller 104 capable of managing the virtual environment. The computing device 102 may also include a networking interface (not shown) that may be used by the inventory agent 106 and/or policy agent 108 to communicate with the inventory server 116. An exemplary single-/multi-processor or processor core computing system of computing environment 102 is illustrated by FIG. 3, and is described in greater detail below. Hereinafter, including in the claims, processor and processor core shall be used interchangeable, with each term including the other.

As is shown, computing device 102 may have one or both of a management controller or a Service Operating System (SOS) 104. In some embodiments, the management controller 104 may be an embedded subsystem of computing device 102 that is below the host operating system level. Such a management controller 104 may, with the exception of inventory agent 106 and policy agent 108, be any sort of subsystem known in the art capable of managing or facilitating the management of a virtual environment, such as the Active Management Technology (AMT) subsystem of the Intel Corporation. The management controller 104 may be implemented as memory storing a series of instructions for monitoring and control functions, and may accomplish management and repair functions transparently to users. Also, as shown, management controller 104 may have one, both, or neither of inventory agent 106 and policy agent 108. Management controllers such as management controller 104 are known in the art, and accordingly will not be described further.

In some embodiments, computing device 102 may have a service operating system (SOS) 104 operating on a partition of computing device 102. SOS 104 may operate with a virtual machine manager (VMM), the VMM and SOS 104 comprising a service partition of the computing device 102, managing the actual hardware resources of computing device 102 and coordinating the use of the resources among the plurality of virtual machines 110. Also, as shown, inventory agent 106 and/or policy agent 108 may reside in the SOS 104 partition. In some embodiments, SOS 104 may receive all instructions to instantiate or shut down VM 110s prior to the execution of the instructions. This may include instructions from processes running on the SOS 104 as well as processes running on other OSes of other VMs 110, and instructions from other computing devices. With the exception of inventory agent 106 and policy agent 108, SOS 104 may be any sort of SOS known in the art. SOSes are well known in the art, and thus will not be described further.

As is shown, inventory agent 106 may reside in either of SOS 104 or management controller 104. Inventory agent 106 may comprise one or more modules of programming instructions of any language executable as a single- or multi-threaded process. Also, inventory agent 106 may be operated by a processor of the computing device 102, which may be a processor dedicated to inventory agent 106 and/or policy agent 108. By providing inventory agent 106 with a dedicated processor, computing device 102 prevents the operations of inventory agent 106 from being disrupted by a denial of service attack.

In various embodiments, inventory agent 106 may be initialized at the start-up of computing device 102, or may be initialized in response to an inventory server 116 command or in response to the instantiation of a first VM 110. Once initialized, inventory agent 106 may determine a count of VMs 110 on computing device 102, and may notify the inventory server 116 of the determined count. In some embodiments, inventory agent 106 may perform the determining and notifying repeatedly, on a periodic basis. In addition to determining a count, inventory agent 106 may also, in various embodiments, determine a name, a size, a type, and/or a function of each VM 110. Upon determining a count and names, sizes, types, and/or functions, inventory agent 106 may store the determine data in a database or file of computing device 102 or another computing device. The database or file may have a table/record for each VM and for the count. In some embodiments, the database or file may store the results of a number of determinations, allowing the count, for example, to be tracked over a period of time.

In some embodiments, upon determining the count, inventory agent 106 may compare the count to a previous count of VMs 110 to determine if any VMs 110 have been instantiated or shut down since a last determination. In one embodiment, inventory agent 106 may then perform the above mentioned notifying conditionally, only notifying inventory server 116 if the any VMs 110 have been instantiated or shut down (i.e, the count has changed).

The notification provided to inventory server 116 may include the determined count, and may also include names, sizes, types, and functions of VMs. In some embodiments, the notification may also include a date-time stamp, or other pertinent information.

As illustrated, policy agent 108 may reside in either of SOS 104 or management controller 104. Policy agent 108 may comprise one or more modules of programming instructions of any language executable as a single- or multi-threaded process. Also, policy agent 108 may be operated by a processor of the computing device 102, which may be a processor dedicated to policy agent 108 and/or inventory agent 106. By providing policy agent 108 with a dedicated processor, computing device 102 prevents the operations of policy agent 108 from being disrupted by a denial of service attack.

In some embodiments, policy agent 108 may be initialized and begin operation at the start up of computing device 102, and may continue operation until computing device 102 is shut down. Policy agent 108 may receive all instructions to instantiate or shut down VMs 110. The instructions may be received from processes of any one of the VMs 110 of computing device 102, or from another computing device, and may be detected in any manner known in the art, including monitoring by policy agent 108. Upon receiving such an instruction, policy agent 108 may compare the action requested by the instruction to thresholds or metrics of a policy, which may be stored on computing device 102 or on another computing device. The policy may set thresholds/metrics for a maximum number of VMs 110 that may be instantiated, a VM 110 type that can not be shut down, or a maximum number of VMs 110 of a given type that may be instantiated, but may include any other sort of thresholds/metrics known in the art. In determining the current number of VMs 110 or the types of VMs 110, policy agent 108 may make reference to the data determined by inventory agent 106, described above in greater detail. As mentioned, such data may be stored in database or file of computing device 102, in the management controller 104, SOS 104, or in one of the other VMs 110. Upon comparing the instruction to such data, policy agent 108 may determine whether the instruction conforms to the policy. If the instruction does not conform to the policy, policy agent 108 may disallow the instruction, and if the instruction does conform, policy agent 108 may allow the instruction to be executed, thereby allowing a new VM 110 to be instantiated or a current VM 110 to be shut down.

In some embodiments, policy agent 108 may notify server device 114 or another server in the same manner as described above for inventory agent 106. Policy agent 108 may notify a server each time it disallows an instruction, or after it has reached a threshold number of disallowances. Such notification may comprise an error code or error codes, and/or the instruction(s) that were disallowed.

In various embodiments, plurality of virtual machines 110, except for the teachings of the embodiments of the present invention, may be any sort of virtual machines. Each virtual machine 110 may be a self-contained operating environment that behaves as if it is a separate computer system. The virtual machines 110 may also each have an OS capable of managing multiple processes and may each have a protected memory space that operationally belongs exclusively to that virtual machine 110. As described above, one of the VMs 110 may be a VMM and may have an SOS 104, in some embodiments. Other VMs 110 may have capability operating systems (COS) or virtual operating systems (VOS). Suitable virtual machines and virtualization technologies include but are not limited to those available from Microsoft Corporation of Redmond, Wash., and XenSource of Cambridge, UK.

As is shown, computing device 102 and server device 114 may be connected by a networking fabric 112. The networking fabric 112 connecting the computing systems may be any sort of networking fabric known in the art, such as one or more of a local area network (LAN), a wide area network (WAN), and the Internet. In various embodiments, the networking fabric may comprise a private LAN or WAN of an enterprise. The parties to the connection, here computing device 102 and server device 114, may further use any communication protocol known in the art, such as the Hypertext Transfer Protocol (HTTP), and any transport protocol known in the art, such as the Transmission Control Protocol/Internet Protocol (TCP/IP) suite of protocols. As mentioned, each of computing device 102 and server device 114 may have a networking interface to facilitate networked communication across networking fabric 112.

In various embodiments, server device 114 may be any single- or multi-processor central processing unit (CPU) computing system. Server device 114 may be a PC, a workstation, a server, a router, a mainframe, a modular computer within a blade server or high-density server, a personal digital assistant (PDA), an entertainment center, a set-top box, or a mobile device. In some embodiments, server device 114 may be capable of operating a plurality of OSes in a plurality of VMs 110 using virtualization technologies. The server device 114 may also include a networking interface (not shown) that may used by the inventory server 116 to communicate with the inventory agent 106. In various embodiments, the server device 114 may have a storage device component capable of storing one or more databases or files, such as those described further below. An exemplary single-/multi-processor computing system of computing environment 102 is illustrated by FIG. 3, and is described in greater detail below.

As illustrated, server device 114 may comprise an inventory server 116 that is adapted to receive notifications from inventory agent 106 and from other inventory agents of other computing devices and to store such notifications. Inventory server 116 may comprise one or more modules of programming instructions of any language executable as a single- or multi-threaded process. The server 116 may be operated by a processor of device 114, and may be stored on a storage device of server 116 or another computing device. When operated, inventory server 116 may receive notifications from a plurality of inventory agents, such as inventory agent 106. As described above, notifications may include a count of the plurality of virtual machines 110 on a computing device 102, the name of a VM 110, the size of a VM 110, the type of a VM 110, and/or the function of a VM 110. Upon receiving a notification, server 116 may store the notification in one or more databases or files. If in a database, the database may include a table/record for each computing device 102 and/or for each VM 110. In addition to storing the notifications, inventory server 116 may, in some embodiments, have or be associated with a monitoring process. Such a monitoring process may monitor for a certain change in count, VM 110 size, etc., and may trigger an alert if a threshold is reached. Such an alert may then be provided to system administration personnel.

In other embodiments, the inventory server 116 or some other process of server device 114 may be adapted to receive notifications from the policy agent 108 when the policy agent 108 disallows an instruction to shut down or instantiate a virtual machine 110. The notification may include an error code and/or the disallowed instruction itself. The notification may then be stored by the server 116 or other process in a database or file, which may be the same or different as the database or file storing notifications received from inventory agent 106. In some embodiments, in addition to storing the notification, the server 116 or process may monitor for a certain error code, number of error codes, instruction, or number of the same type of an instruction, and may trigger an alert if a threshold is reached. Such an alert may then be provided to system administration personnel.

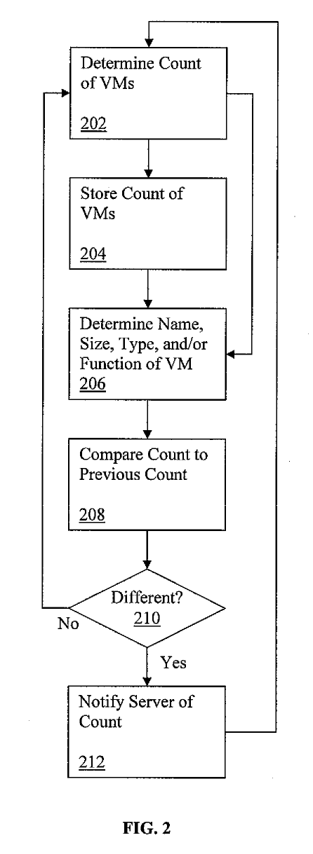

FIG. 2 illustrates a flow chart view of selected operations of the methods of various embodiments of the present invention. As illustrated, in some embodiments, an inventory agent of a computing device may determine a count of the number of virtual machines operating on the computing device, block 202. In some embodiments, the inventory agent may reside in a management controller or a service operating system of the computing device, and may be associated with a processor of the computing device that is dedicated to the inventory agent. Upon determining the count, the inventory agent may store the count in a database or file of the computing device, block 204, and the database or file may store previous counts, along with the current count, over a period of time. Also, in some embodiments, the inventory agent may determine names, sizes, types, and/or functions of the virtual machines of the computing device, block 206. Upon determining these, the inventory agent may store them as well in the database or file, in with a table/record corresponding to each virtual machine, for example.

In some embodiments, the inventory agent may then compare the determined count to a previous count to determine whether any virtual machines have been instantiated or shut down since the previous count, block 208. As mentioned, the previous count may have been stored in the database or file. Each count may simply consist of a numerical value. If the counts different, decision block 210, the inventory agent may then notify an inventory server of the new count, block 212. The inventory server may be a service of a remote server device connectable to the computing device via a networking fabric. The inventory server may be adapted to at least receive and store the counts of the computing device and potentially other computing devices. If the counts are the same, decision block 210, the inventory agent may not notify the inventory server.

Further, as is shown, blocks 202-212 may be repeated. In some embodiments, the inventory agent may be capable of first performing the blocks on initialization, and thereafter periodically performing blocks 202-212 (using fixed and/or variable periods), providing continuous monitoring of the number of virtual machines on the computing device.

FIG. 3 illustrates an example computer system suitable for use to practice various embodiments of the present invention. As shown, computing system 300 includes a number of processors or processor cores 302, and system memory 304. For the purpose of this application, including the claims, the terms “processor” and “processor cores” may be considered synonymous, unless the context clearly requires otherwise. Additionally, computing system 300 includes mass storage devices 306 (such as diskette, hard drive, compact disc read only memory (CDROM) and so forth), input/output devices 308 (such as keyboard, cursor control and so forth) and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing the various components, such as the inventory agent, the policy agent, and so forth, herein collectively denoted as 322. The various components may be implemented by assembler instructions supported by processor(s) 302 or high-level languages, such as C, that can be compiled into such instructions.

The permanent copy of the programming instructions may be placed into permanent storage 306 in the factory, or in the field, through, for example, a distribution medium (not shown), such as a compact disc (CD), or through communication interface 310 (from a distribution server (not shown)). That is, one or more distribution media having an implementation of the agent program may be employed to distribute the agent and program various computing devices.

The constitution of these elements 302-312 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
determining, by an inventory agent of a computing device, the computing device adapted to instantiate a plurality of virtual machines, a count of the plurality of virtual machines on the computing device; and
notifying, by the inventory agent of the computing device, an inventory server external to the computing device of the determined count.

2. The method of claim 1, wherein the inventory agent is located on either a low-level management controller of the computing device or a service operating system partition of the computing device.

3. The method of claim 1, wherein said determining and said notifying are performed by a processor of the computing device, the computing device having a plurality of processors, and the processor is dedicated to the inventory agent.

4. The method of claim 1, wherein said determining comprises additionally determining one or more of a name, a size, a type, or a function for at least one of the plurality of virtual machines.

5. The method of claim 1, further comprising comparing the determined count to a previous count of the plurality of virtual machines to determine whether a virtual machine has been instantiated or shut down since the previous count.

6. The method of claim 5, wherein said notifying is performed upon said determination that a virtual machine has been instantiated or shut down.

7. The method of claim 1, further comprising storing the determined count of the plurality of virtual machines.

8. The method of claim 1, wherein at least one of the plurality of virtual machines has a capability operating system, a service operating system, or a virtual operating system.

9. The method of claim 1, wherein said determining is performed repeatedly, on a periodic basis.

10. An apparatus comprising:
a processor; and
a management controller coupled to the processor and having either or both of
(1) an inventory agent operated by the processor and adapted to
determine a count of a plurality of virtual machines of the apparatus, and
notify an inventory server external to the apparatus of the determined count, or
(2) a policy agent operated by the processor and adapted to
receive an instruction to instantiate or shut down a virtual machine of the plurality of virtual machines of the apparatus, and
conditionally disallow the instruction if the instruction does not meet criteria specified by a policy.

11. The apparatus of claim 10, wherein the processor is dedicated to one or both of the inventory agent and the policy agent, and the apparatus comprises one or more additional processors.

12. The apparatus of claim 10, wherein the inventory agent is further adapted to additionally determine one or more of a name, a size, a type, or a function for at least one of the plurality of virtual machines.

13. The apparatus of claim 10, wherein the inventory agent is further adapted to compare the determined count to a previous count of the plurality of virtual machines to determine whether a virtual machine has been instantiated or shut down since the previous count.

14. The apparatus of claim 13, wherein the inventory agent is further adapted to said notify, and said notify is performed upon said determination that a virtual machine has been instantiated or shut down.

15. The apparatus of claim 10, wherein the inventory agent is further adapted to store the determined count of the plurality of virtual machines.

16. The apparatus of claim 10, wherein at least one of the plurality of virtual machines has a capability operating system, a service operating system, or a virtual operating system.

17. The apparatus of claim 10, wherein the inventory agent is further adapted to said determine, and said determine is performed repeatedly, on a periodic basis.

18. The apparatus of claim 10, wherein the criteria of the policy include one or more of a maximum number of virtual machines that may be instantiated, a virtual machine type that can not be shut down, or a maximum number of virtual machines of a given type that may be instantiated.

19. The apparatus of claim 10, wherein the policy agent is further adapted to notify the inventory server or another server if a received instruction is disallowed.

20. An article of manufacture comprising:
a storage medium; and
a plurality of programming instructions stored on the storage medium and configured to program an apparatus to
receive an instruction to instantiate or shut down a virtual machine of a plurality of virtual machines of the apparatus, and
conditionally disallow the instruction if the instruction does not meet criteria specified by a policy.

21. The article of claim 20, wherein the plurality of programming instructions are configured to instantiate a policy agent to said receive and said conditionally disallow, and the policy agent is to be instantiated in a service operating system of the apparatus.

22. The article of claim 21, wherein the criteria of the policy include one or more of a maximum number of virtual machines that may be instantiated, a virtual machine type that can not be shut down, or a maximum number of virtual machines of a given type that may be instantiated.

23. The article of claim 20, wherein the plurality of programming instructions are further configured to program an apparatus to notify a server if a received instruction is disallowed.

24. A system comprising:
a processor;
a storage device coupled to the processor and adapted to store a count of a plurality of virtual machines of at least one computing device coupled to the system; and
an inventory service operated by the processor and adapted to
receive the count of the plurality of virtual machines of the at least one computing device from an inventory agent of the computing device, and the inventory agent is adapted to notify the inventory service each time the count changes, and
store the received count in the storage device.

25. The system of claim 24, wherein the inventory service is further adapted to additionally receive one or more of a name, a size, a function, or a type for at least one of the plurality of virtual machines of the at least one computing device and to additionally store the received name, size, function, or type.
